(19) United States
(12) Patent Application Publication
(10) Pub. No.: US 2014/0319239 A1
(43) Pub. Date: Oct. 30, 2014

(54) Thermal Management System Comprising A Heat Pipe, Heat Fins And A Synthetic Jet Ejector

(71) Applicant: Nuventix, Inc., Austin, TX (US)

(72) Inventors: Raghavendran Mahalingam, Austin, TX (US); Randall P. Williams, Austin, TX (US); Stephen P. Darbin, Austin, TX (US); Brandon Lee Noska, Hallettsville, TX (US); Lee M. Jones, Austin, TX (US)

(73) Assignee: Nuventix, Inc., Austin, TX (US)

(21) Appl. No.: 14/179,812

(22) Filed: Feb. 13, 2014

Related U.S. Application Data
(60) Provisional application No. 61/768,189, filed on Feb. 22, 2013.

(51) Int. Cl. B05B 17/06

(52) U.S. Cl. CPC B05B 17/0653
USPC 239/102.2

(57) ABSTRACT

A device is provided which includes (a) a thermally conductive base having first and second major surfaces; (b) a die attached to said first major surface of said base; (c) a heat pipe having a first end which is attached to said second major surface of said base; (d) a plurality of heat fins attached to a second end of said heat pipe; and (e) at least one synthetic jet ejector disposed between said base and said plurality of heat fins.

### CROSS-REFERENCE TO RELATED APPLICATION

This application claims the benefit of priority to U.S. Provisional Application No. 61/768,189, filed Feb. 22, 2013, having the same title, and the same inventors, and which is incorporated by reference herein in its entirety.

### FIELD OF THE DISCLOSURE

The present disclosure relates generally to synthetic jet ejectors, and more particularly to thermal management systems which comprise a heat pipe, heat fins and a synthetic jet ejector.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System”; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is a perspective view of a first embodiment of a synthetic jet ejector engine in accordance with the teachings herein.

FIG. 3 is a perspective view of the embodiment of FIG. 2.

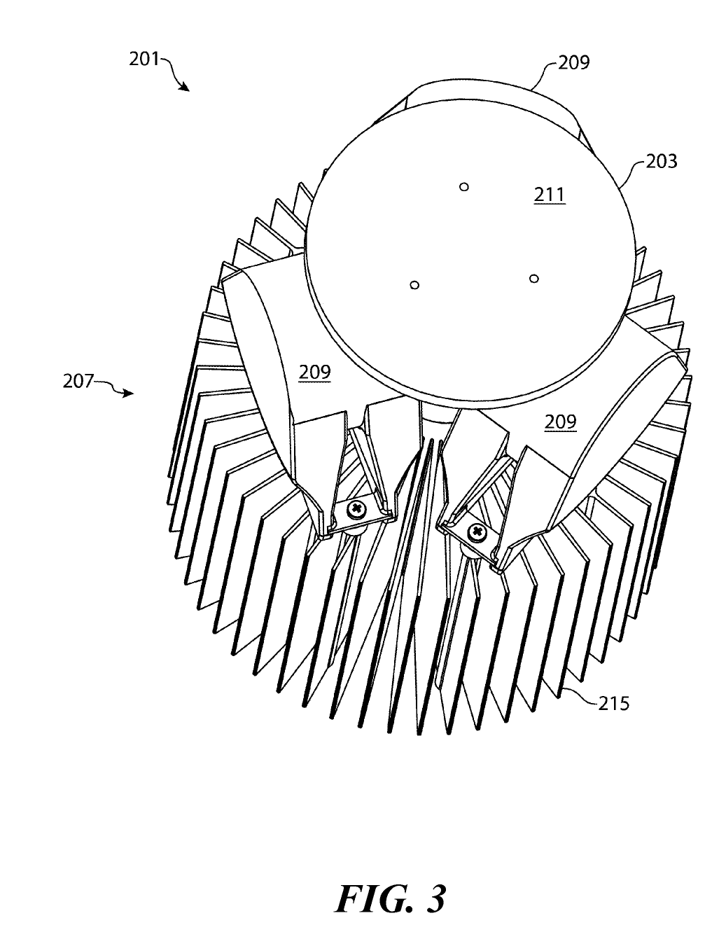

FIG. 4 is a perspective view of the embodiment of FIG. 2.

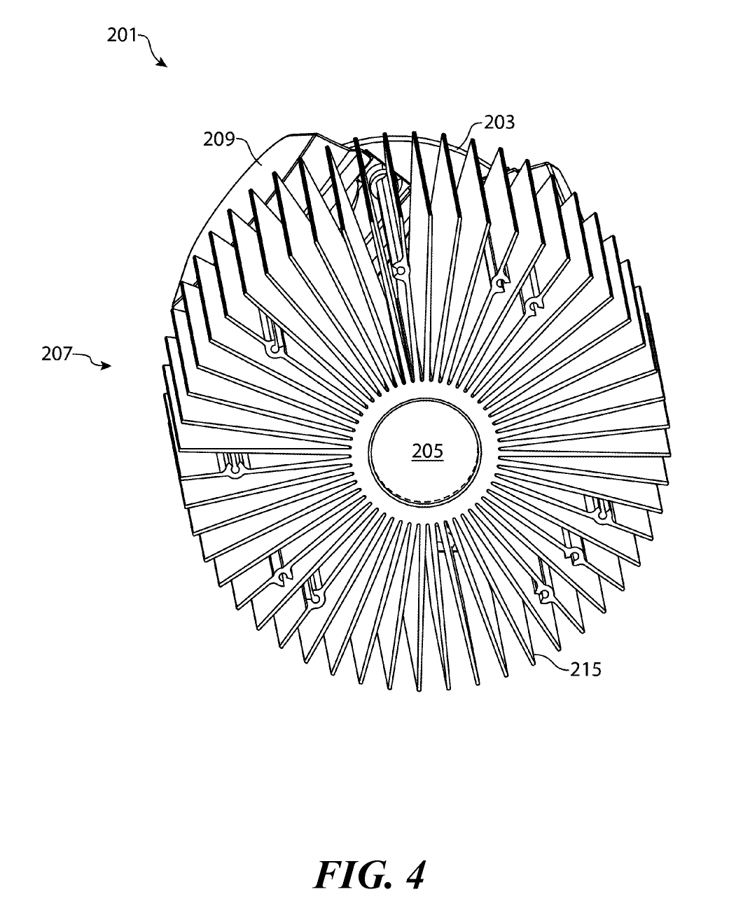

FIG. 5 is a perspective view of the embodiment of FIG. 2.

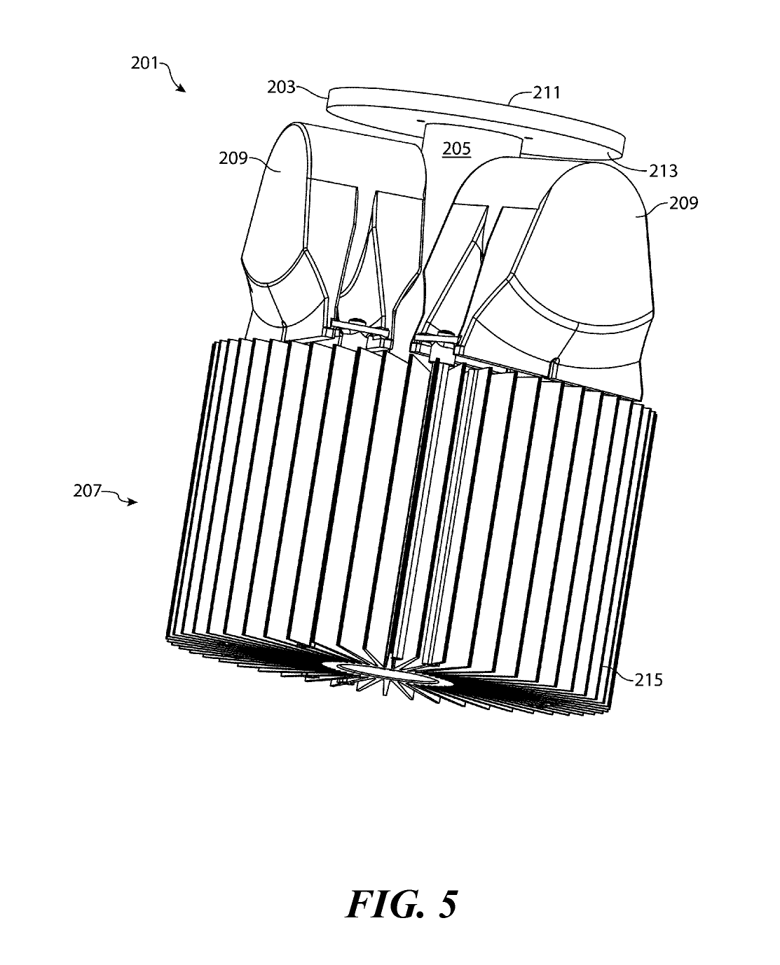

FIG. 6 is a side view of the embodiment of FIG. 2.

FIG. 7 is a cross-sectional view taken along PLANE 7-7 of FIG. 6.

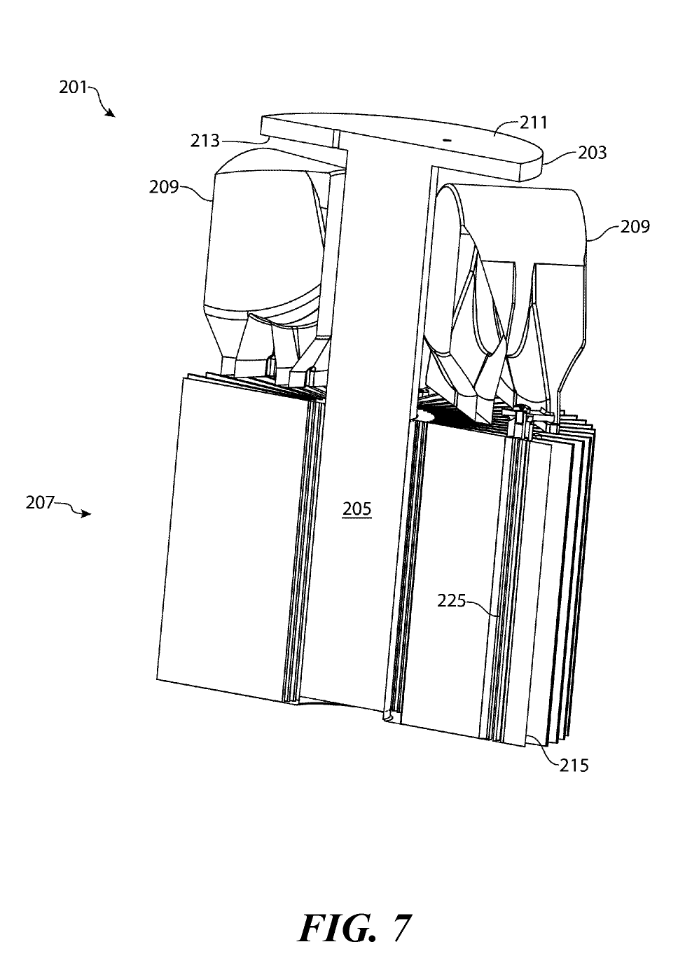

FIG. 8 is a bottom view of the heat fins of the embodiment of FIG. 2.

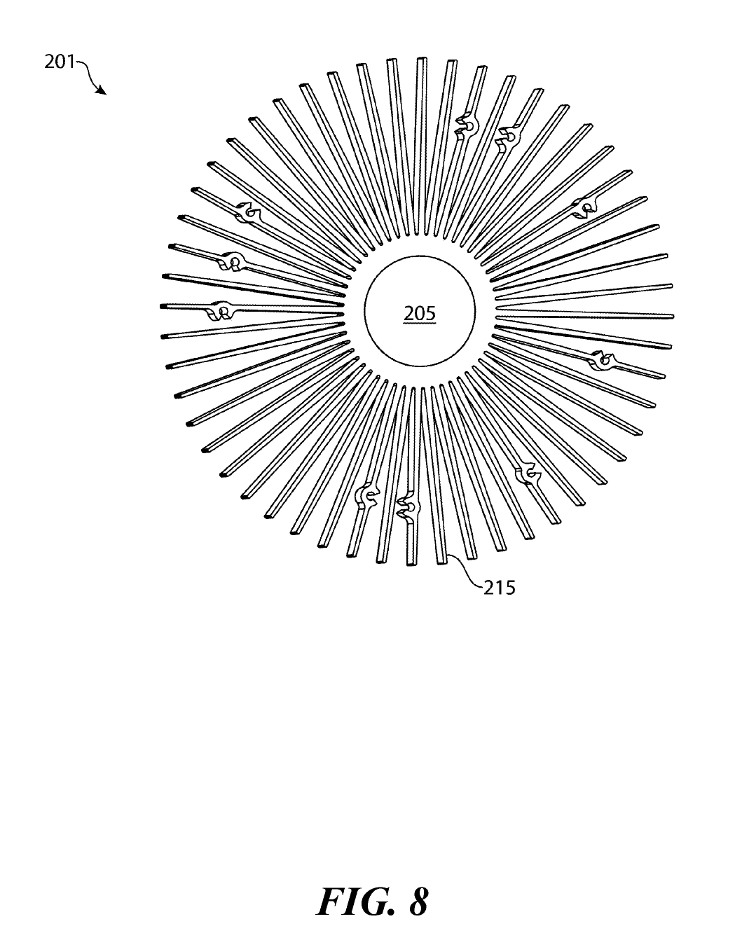

FIG. 9 is a top view of the embodiment of FIG. 2.

FIG. 10 is a bottom view of the embodiment of FIG. 2.

FIG. 11 is a magnified view of portions of the heat fins of the embodiment of FIG. 2 showing the details of the longitudinal slot.

FIG. 12 is an exploded view of the embodiment of FIG. 2.

FIG. 13 is a perspective view of the synthetic jet ejector component of a synthetic jet ejector engine in accordance with the teachings herein, and includes a magnified view of the flange element thereof which may be used to fasten the synthetic jet ejector to a heat sink.

### SUMMARY OF THE DISCLOSURE

In one aspect, a device is provided which comprises (a) a thermally conductive base having first and second major surfaces; (b) a die attached to said first major surface of said base; (c) a heat pipe having a first end which is attached to said second major surface of said base; (d) a plurality of heat fins attached to a second end of said heat pipe; and (e) at least one synthetic jet ejector disposed between said base and said plurality of heat fins.

### DETAILED DESCRIPTION

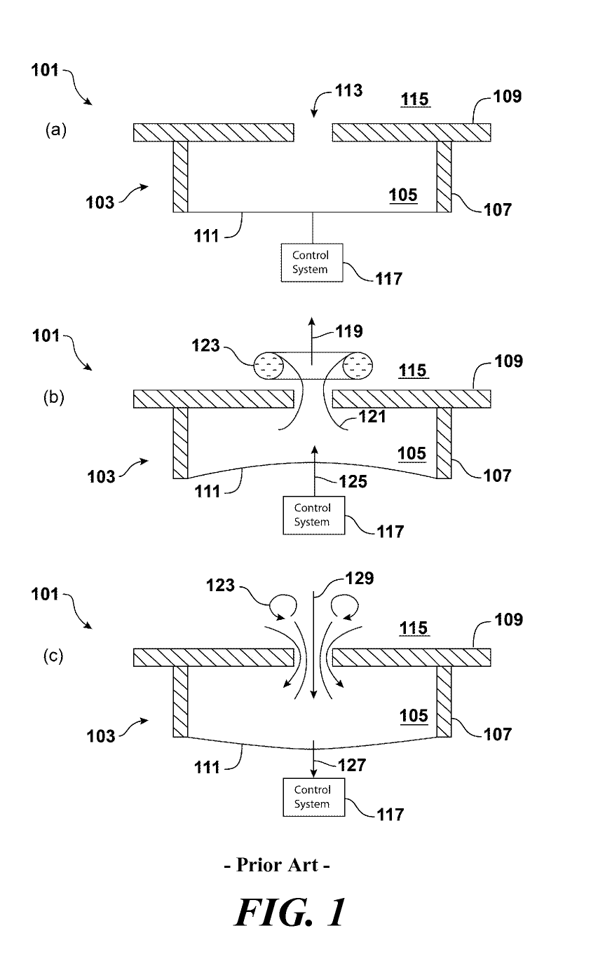

The operation of a synthetic jet ejector and the formation of a synthetic jet may be appreciated with respect to FIG. 1. FIG. 1a depicts a synthetic jet ejector 101 comprising a housing 103 which defines and encloses an internal chamber 105. The housing 103 and chamber 105 may take virtually any geometric configuration, but for purposes of discussion and understanding, the housing 103 is shown in cross-section in FIG. 1a to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein (see FIG. 1) which may be of various geometric shapes. The orifice 113 diametrically opposes the rear diaphragm 111 and fluidically connects the internal chamber 105 to an external environment having ambient fluid 115.

The movement of the flexible diaphragm 111 may be controlled by any suitable control system 117. For example, the diaphragm may be moved by a voice coil actuator. The diaphragm 111 may also be equipped with a metal layer, and a metal electrode may be disposed adjacent to, but spaced from, the metal layer so that the diaphragm 111 can be moved via an electrical bias imposed between the electrode and the metal layer. Moreover, the generation of the electrical bias can be controlled by any suitable device, for example but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-FIG. 1c. FIG. 1b depicts the synthetic jet ejector 101 as the diaphragm 111 is controlled to move inward into the chamber 105, as depicted by arrow 125. The chamber 105 has its volume decreased and fluid is ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The chamber 105 has its volume increased and ambient fluid 115 rushes into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

Many improvements have been made to the design of synthetic jet ejectors since their initial introduction. However, the need exists for even further improvements in the design of these devices. In particular, some applications require thermal management solutions which are highly compact, and which can accommodate certain geometrical constraints, such as cylindrical spaces. Some of these applications also additionally require the locus at which heat is dissipated into the atmosphere to be removed from the heat source. Some of these applications further require the ability for an end user or manufacturer to be able to adjust the thermal management capacity of a host device after the synthetic jet ejector (or its spatial footprint) has already been incorporated into the device. These design constraints cannot be met with many of the thermal management designs proposed to date.

It has now been found that the foregoing needs may be addressed with the devices and methodologies disclosed herein. These devices and methodologies may be utilized to provide thermal management solutions which are highly compact, which can accommodate certain geometrical constraints (such as cylindrical spaces), and which permit the locus at which heat is dissipated into the atmosphere to be removed from the heat source. Moreover, these devices may be produced as modular units, and/or as units which provide manufacturers or end users with the ability to increase the thermal capacity of the thermal management system through the addition of further synthetic jet ejectors or synthetic jet actuators to the existing structure or footprint of the thermal management system. These devices and methodologies are described in greater detail below.

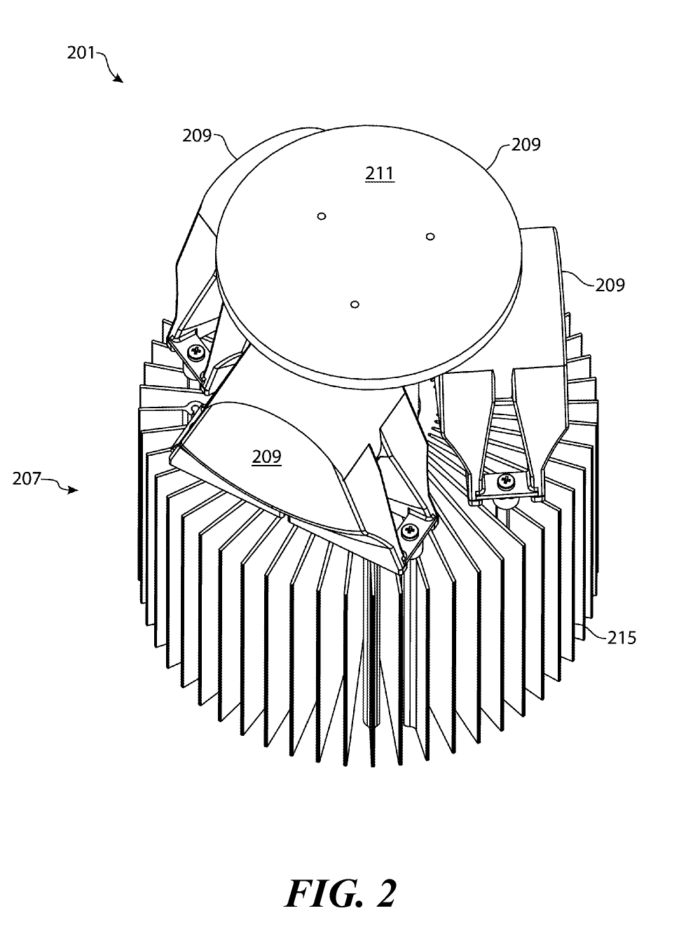

FIG. 2 depicts a first particular, non-limiting embodiment of a thermal management system in accordance with the teachings herein. The thermal management system 201 depicted therein comprises a base 203, a heat pipe 205, a heat sink 207 and a plurality of synthetic jet ejectors 209.

The base 203 has first 211 and second 213 major surfaces and preferably comprises a thermally conductive material. Various materials may be used in the construction of the base including, for example, copper, aluminum, thermally conductive polymeric materials, and various metals and metal alloys.

In a typically implementation, a die (not shown) is attached to the first major surface 211 of the base 203, and a first end of the heat pipe 205 is attached to the second major surface 213 of the base 203. The attachment of the die or the first end of the heat pipe 205 may be accomplished mechanically, through the use of a suitable adhesive, or by other suitable means. If an adhesive is used for this purpose, the use of a thermally conductive adhesive is preferred.

A second end of the heat pipe 205 is in thermal communication with, and is preferably attached to, the heat sink 207. The attachment of the heat pipe 205 to the heat sink 207 may be accomplished mechanically, through the use of a suitable adhesive, or by other suitable means. If an adhesive is used for this purpose, the use of a thermally conductive adhesive is preferred. The heat sink 207 may have various configurations, but preferably comprises a plurality of heat fins 215 which are disposed radially about the center of the heat sink 207 and the heat pipe 205.

The base 203 is preferably spaced apart from the heat sink 207. At least one, and preferably a plurality, of synthetic jet ejectors 209 are disposed in the space between the base 203 and the heat sink 207. Each synthetic jet ejector 209 preferably emits a plurality of synthetic jets, and each synthetic jet is directed into the channel defined by adjacent heat fins 215 in the heat sink 207.

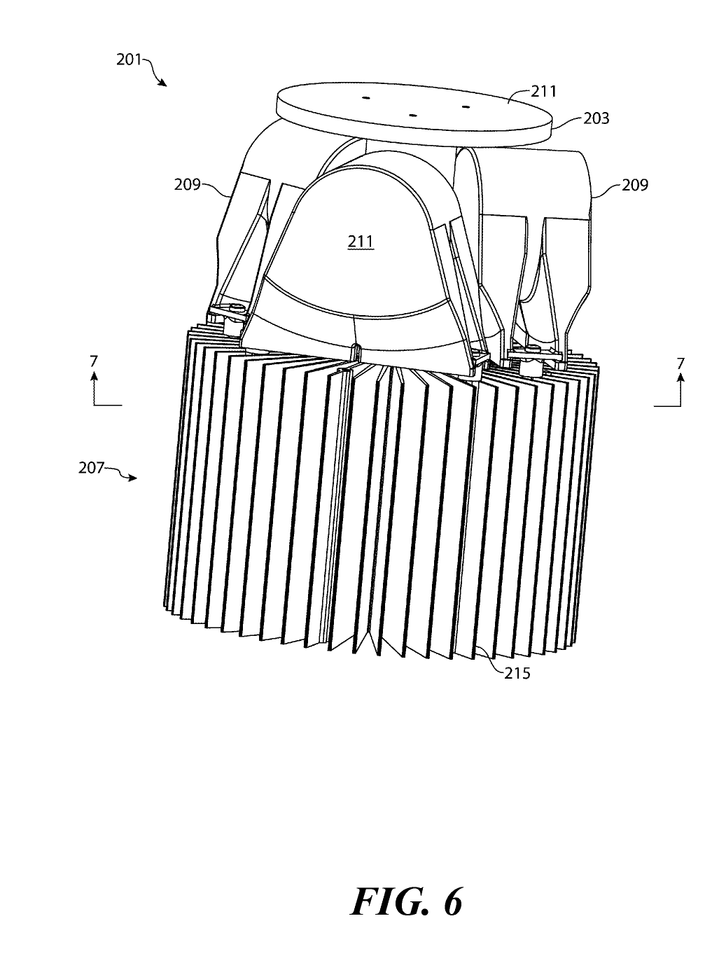

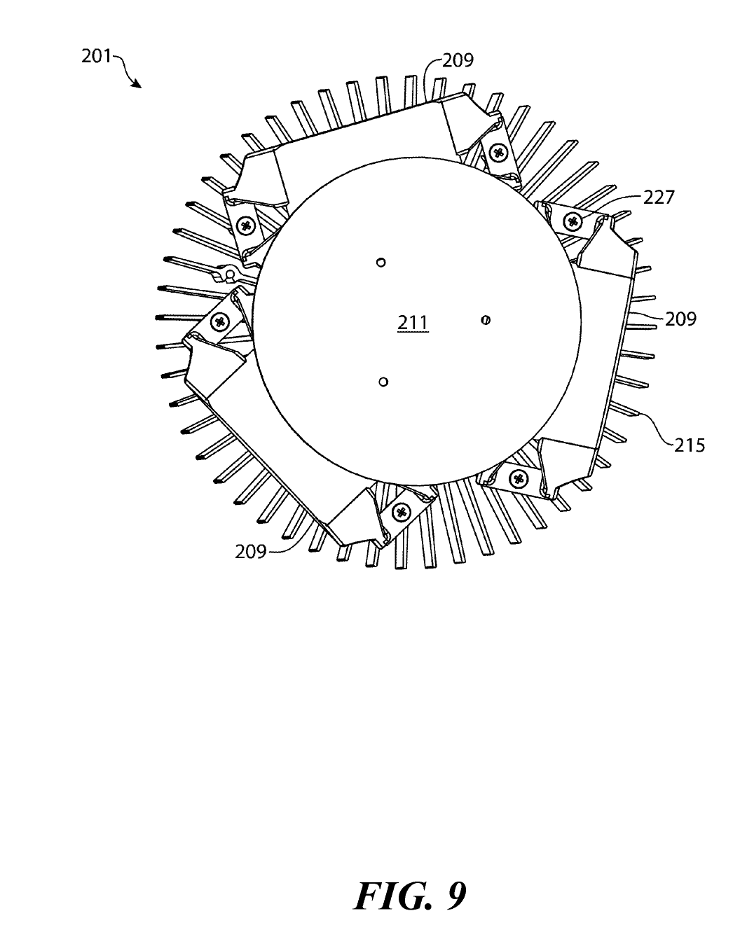

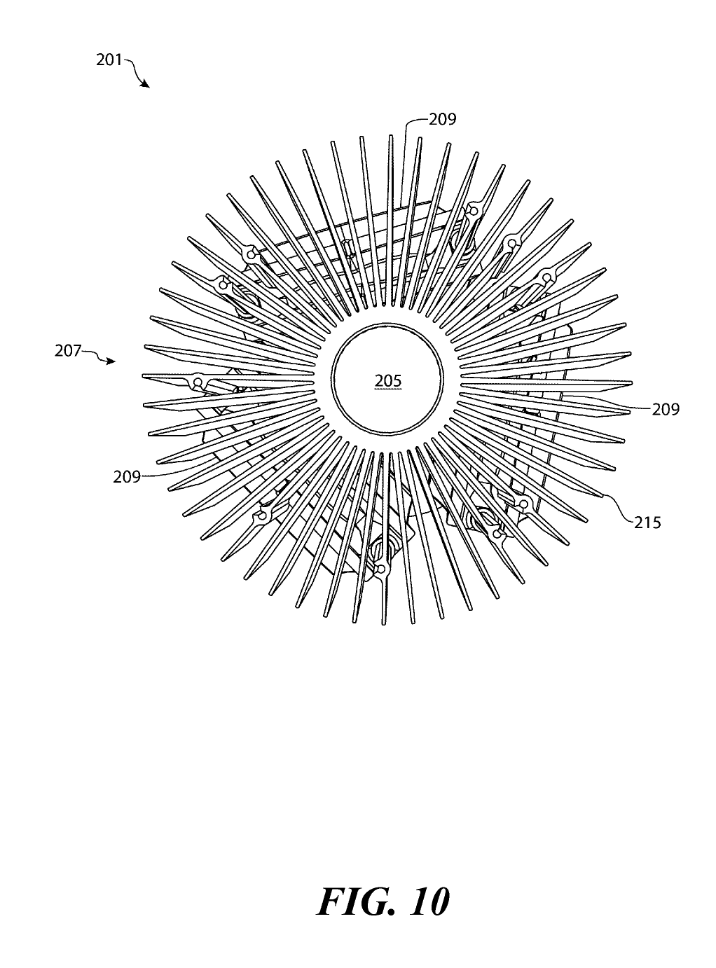

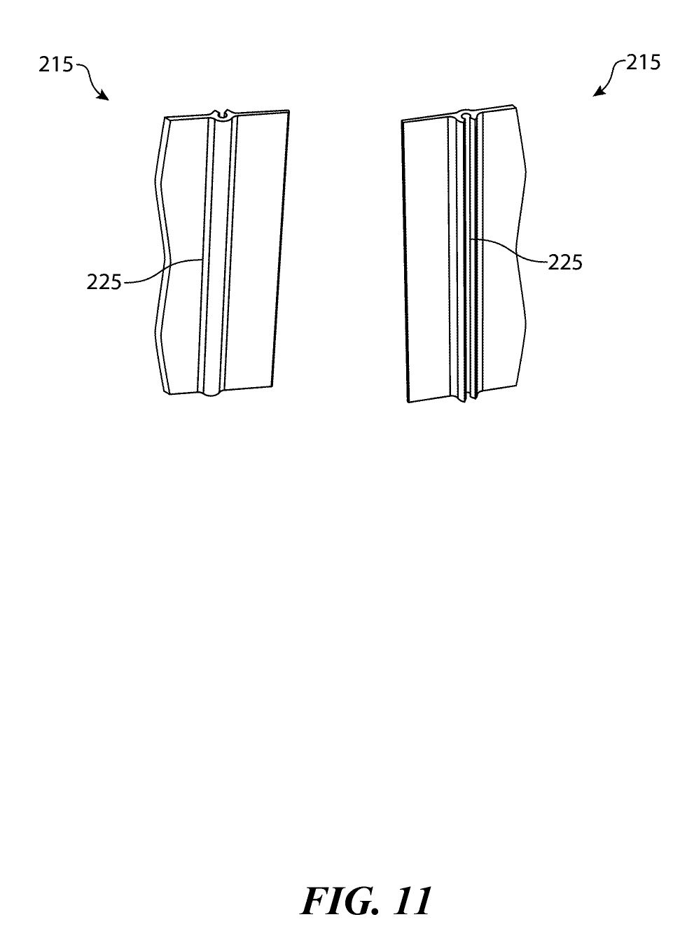

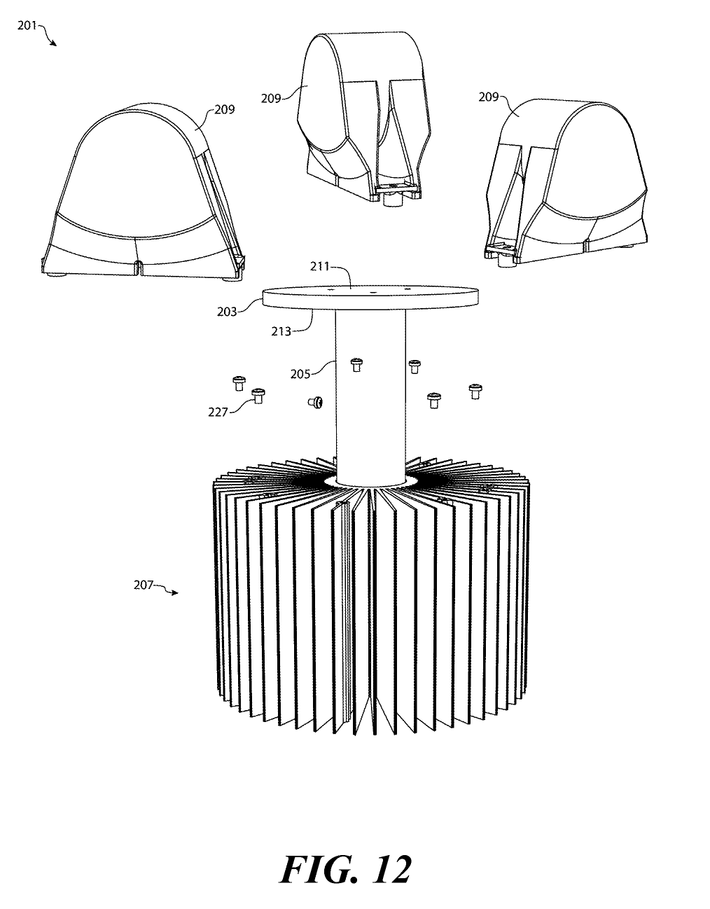

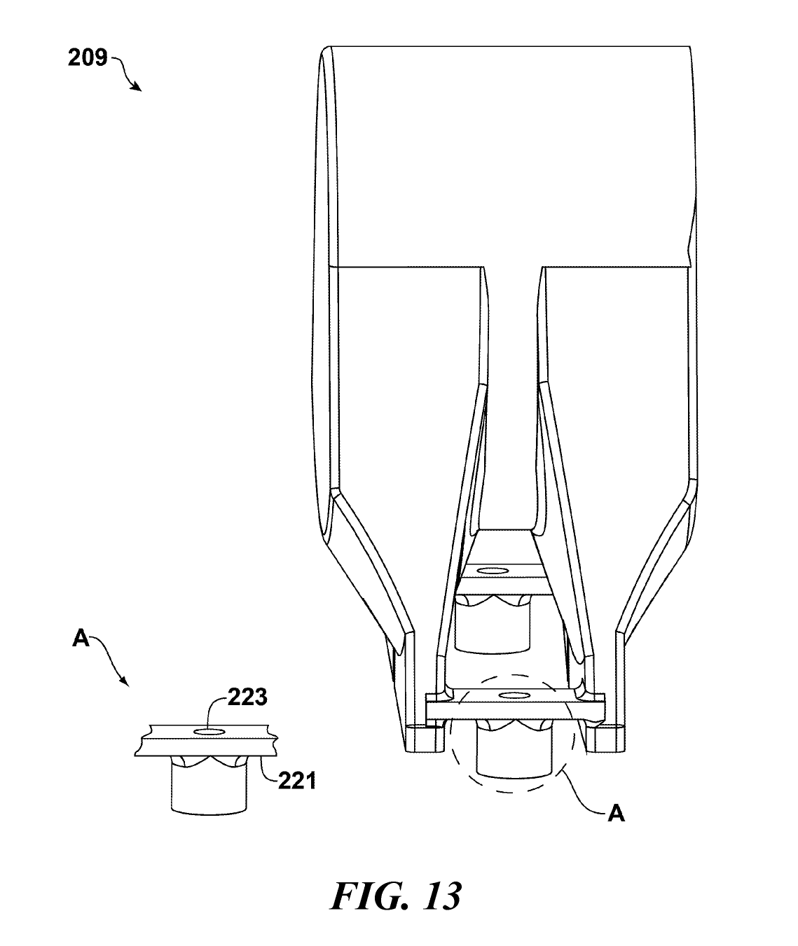

The manner in which the synthetic jet ejectors 209 may be attached to the heat sink 207 may be understood with reference to FIGS. 6 and 9-13. As best seen in FIG. 13, each synthetic jet ejector 209 is equipped with at least one, and preferably a plurality, of flanges 221. A magnified view of region A of the synthetic jet ejector 209 shows the flange 221 in greater detail. Each flange 221 is preferably equipped with a threaded aperture 223. Similarly, as seen in FIGS. 6 and 11, some of the heat fins 215 in the heat sink 207 are equipped with a longitudinal slot 225. The synthetic jet ejector 209 may thus be fastened to the heat sink 207 by positioning the threaded aperture 223 over the longitudinal slot 225, and then extending a threaded fastener 227 of appropriate dimensions through the threaded aperture 223 and into the longitudinal slot 225 as seen, for example, in FIG. 9. Of course, it will be appreciated that various other means may also be used to fasten the synthetic jet ejector 209 to the heat sink 207.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A device, comprising:
a thermally conductive base having first and second major surfaces;
a die attached to said first major surface of said base;
a heat pipe having a first end which is attached to said second major surface of said base;
a plurality of heat fins attached to a second end of said heat pipe; and
at least one synthetic jet ejector disposed between said base and said plurality of heat fins.

2. The device of claim 1, wherein said heat fins extend radially from said heat pipe.

3. The device of claim 1, wherein said at least one synthetic jet ejector directs at least one synthetic jet into a channel formed by adjacent ones of said plurality of heat fins.

4. The device of claim 1, wherein said at least one synthetic jet ejector is a plurality of synthetic jet ejectors.

5. The device of claim 1, wherein said at least one synthetic jet ejector includes first and second synthetic jet ejectors, wherein said first synthetic jet ejector ejects a first plurality of synthetic jets, and wherein said second synthetic jet ejector ejects a second plurality of synthetic jets.

6. The device of claim 5, wherein said plurality of heat fins has a plurality of channels defined therein, and wherein said first synthetic jet ejector directs each of said first plurality of synthetic jets into one of said plurality of channels.

7. The device of claim 6, wherein said second synthetic jet ejector directs each of said second plurality of synthetic jets into one of said plurality of channels.

8. The device of claim 6, wherein each of said plurality of channels is defined by a pair of adjacent ones of said plurality of heat fins.

9. The device of claim 1, wherein said heat fins extend radially from said heat pipe, and wherein each of said plurality of heat fins has first and second opposing major surfaces.

10. The device of claim 9, wherein said first and second opposing major surfaces are parallel to a major axis of said heat pipe.

11. The device of claim 10, wherein each of said plurality of heat fins has a first end, and wherein the first ends of said plurality of heat fins lie in a first common plane.

12. The device of claim 10, wherein each of said plurality of heat fins has a second end, and wherein the second ends of said plurality of heat fins lie in a second common plane.

13. The device of claim 11, wherein said at least one synthetic jet ejector has a plurality of apertures defined therein, and wherein each of said plurality of apertures is spaced apart from said first common plane.

14. The device of claim 13, wherein said at least one synthetic jet ejector is secured to a first heat fin from said plurality of heat fins by a first connector which extends across the first and second major surfaces of said first heat fin.

15. The device of claim 14, wherein said at least one synthetic jet ejector is secured to a second heat fin from said plurality of heat fins by a second connector which extends across the first and second major surfaces of said second heat fin.

16. The device of claim 13, wherein said at least one synthetic jet ejector is secured to a first heat fin from said plurality of heat fins by a first protrusion which engages a first slot defined in said first heat fin.

17. The device of claim 16, wherein said first slot extends across the first major surface of said first heat fin.

18. The device of claim 17, wherein said at least one synthetic jet ejector is secured to a second heat fin from said plurality of heat fins by a second protrusion which engages a second slot defined in said second heat fin.

19. The device of claim 18, wherein said second slot extends across the first major surface of said second heat fin.

20. The device of claim 17, wherein each of said plurality of heat fins has a second end, and wherein said first slot extends from the first end to the second end of said first heat fin.

21. The device of claim 20, wherein the second ends of said plurality of heat fins lie in a second common plane.
